(19) United States
(12) Patent Application Publication
(10) Pub. No.: US 2026/0222691 A1
(43) Pub. Date: Jul. 30, 2026

(54) IMAGING DEVICE

(71) Applicant: Japan Display Inc., Tokyo (JP)

(72) Inventor: Tomoyuki ISHIHARA, Tokyo (JP)

(21) Appl. No.: 19/455,061

(22) Filed: Jan. 21, 2026

(30) Foreign Application Priority Data
Jan. 27, 2025 (JP) 2025-011084

(51) Int. Cl. H04N 23/75; G03B 7/00

(52) U.S. Cl. CPC H04N 23/75; G03B 7/00

(57) ABSTRACT

According to an aspect, an imaging device includes: a planar optical sensor comprising a plurality of photodiodes; an optical shutter device that is provided on one side in a first direction with respect to the optical sensor so as to overlap the optical sensor and is capable of switching display of a plurality of code patterns; a subject housing that is provided on one side in the first direction with respect to the optical shutter device so as to overlap the optical shutter device and is configured to accommodate a subject; and a processing circuit configured to bring a portion of the optical shutter device that overlaps one or some of the code patterns as viewed along the first direction into a light-transmitting state, and bring another portion of the optical shutter device into a light-blocking state.

### CROSS-REFERENCE TO RELATED APPLICATION

This application claims the benefit of priority from Japanese Patent Application No. 2025-011084 filed on January 27, 2025, the entire contents of which are incorporated herein by reference.

### BACKGROUND

### 1. Technical Field

What is disclosed herein relates to an imaging device.

### 2. Description of the Related Art

Japanese Patent Application Laid-open Publication No. 2024-001293 (JP-A-2024-001293) discloses an imaging device that includes a lens and an optical sensor (image pickup device). Light from a subject enters the optical sensor through the lens. Japanese Patent No. 5839428 (JP-5839428) discloses a pinhole camera. The pinhole camera includes a pinhole plate provided with a pinhole and an optical sensor (light-receiving element). The light from the subject enters the optical sensor through the pinhole of the pinhole plate.

The imaging device including the lens according to JP- A-2024-001293 needs to have a long focal length, which may increase the overall size of the device. In the pinhole camera according to JP-5839428, the amount of light passing through the pinhole is limited, which may make it difficult to capture clear images.

For the foregoing reasons, there is a need for an imaging device that has a smaller overall size and is capable of capturing clearer images with reduced blur.

### SUMMARY

According to an aspect, an imaging device includes: a planar optical sensor comprising a plurality of photodiodes; an optical shutter device that is provided on one side in a first direction with respect to the optical sensor so as to overlap the optical sensor and is capable of switching display of a plurality of code patterns; a subject housing that is provided on one side in the first direction with respect to the optical shutter device so as to overlap the optical shutter device and is configured to accommodate a subject; and a processing circuit configured to bring a portion of the optical shutter device that overlaps one or some of the code patterns as viewed along the first direction into a light-transmitting state, and bring another portion of the optical shutter device into a light-blocking state.

### BRIEF DESCRIPTION OF THE DRAWINGS

FIG. 1 is a perspective view schematically illustrating an imaging device according to a first embodiment of the present disclosure;

FIG. 2 is an enlarged schematic view of a portion of a code mask sheet;

FIG. 3 is a block diagram illustrating a configuration example of the imaging device according to the first embodiment;

FIG. 4 is a schematic view illustrating a section taken along line IV-IV in FIG. 1;

FIG. 5 is a schematic diagram illustrating a procedure of image processing according to the first embodiment;

FIG. 6 is a flowchart illustrating a method for acquiring first image data according to the first embodiment;

FIG. 7 is a flowchart illustrating a method for obtaining a resultant image according to the first embodiment;

FIG. 8 is a schematic diagram illustrating a procedure of image processing according to a second embodiment of the present disclosure;

FIG. 9 is a perspective view schematically illustrating an imaging device according to a third embodiment of the present disclosure;

FIG. 10 is an enlarged schematic view of a portion of an optical shutter device in FIG. 9;

FIG. 11 is a schematic sectional view taken along line XI-XI in FIG. 10;

FIG. 12A is a plan view of the optical shutter device illustrating a state in which a first code pattern of four code patterns transmits light;

FIG. 12B is a plan view of the optical shutter device illustrating a state in which a second code pattern of the four code patterns transmits light;

FIG. 12C is a plan view of the optical shutter device illustrating a state in which a third code pattern of the four code patterns transmits light; and

FIG. 12D is a plan view of the optical shutter device illustrating a state in which a fourth code pattern of the four code patterns transmits light.

### DETAILED DESCRIPTION

The following describes modes (embodiments) for carrying out the present disclosure in detail with reference to the drawings. The present disclosure is not limited to the description of the embodiments given below. Components described below include those that are easily conceivable by those skilled in the art or those that are substantially identical thereto. In addition, the components described below can be combined as appropriate. What is disclosed herein is merely an example, and the present disclosure naturally encompasses appropriate modifications easily conceivable by those skilled in the art while maintaining the gist of the present disclosure. To further clarify the description, the drawings may schematically illustrate, for example, widths, thicknesses, and shapes of various parts as compared with actual aspects thereof. However, they are merely examples, and interpretation of the present disclosure is not limited thereto. The same component as that described with reference to an already mentioned drawing is denoted by the same reference numeral through the present disclosure and the drawings, and detailed description thereof may not be repeated where appropriate.

In xyz coordinates, an xl side is opposite to an x2 side in an x direction. A yl side is opposite to a y2 side in a y direction. A z1 side is opposite to a z2 side in a z direction. The z1 side is also referred to as the lower side, and the z2 side as the upper side. The z direction is also referred to as a first direction. The z1 side is also referred to as one side in the first direction, and the z2 side as the other side in the first direction.

### First Embodiment

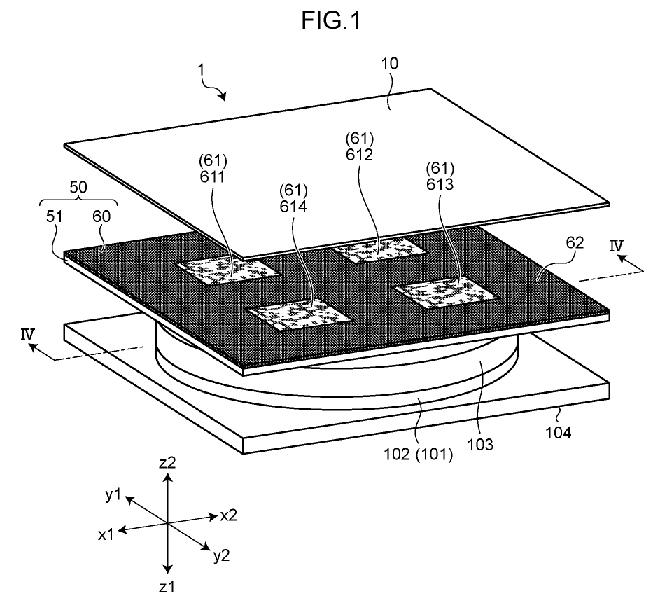

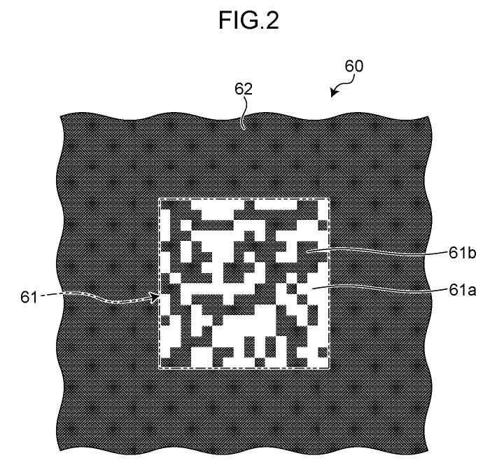

A first embodiment of the present disclosure will first be described. FIG. 1 is a perspective view schematically illustrating an imaging device according to the first embodiment. FIG. 2 is an enlarged schematic view of a portion of a code mask sheet.

As illustrated in FIG. 1, an imaging device 1 includes an optical sensor 10, an optical shutter device 50, a subject housing 103, and a light source 104.

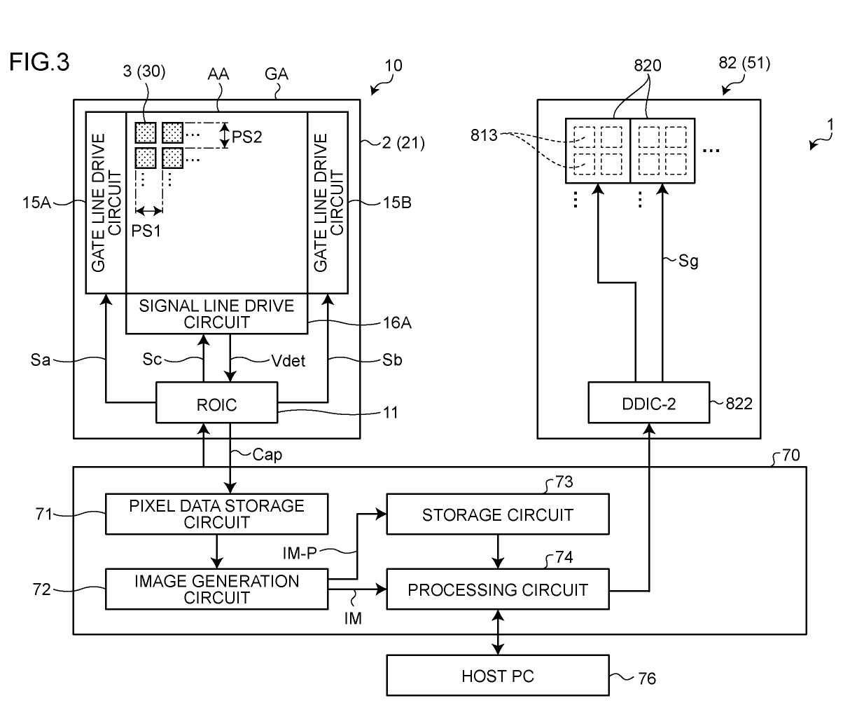

As illustrated in FIG. 1, the optical sensor 10 is a planar detection device that includes a plurality of photodiodes 30 (photodetection elements 813, refer to FIG. 3) arranged in a planar configuration. The optical shutter device 50 is provided on the zl side with respect to the optical sensor 10 so as to overlap the optical sensor 10. The optical shutter device 50 includes a code mask sheet 60 and an optical shutter 51.

The code mask sheet 60 is rectangular in plan view. The term "plan view" refers to "viewed from (along) a direction orthogonal to the optical sensor 10 or the code mask sheet 60" or "viewed from (along) the z direction". The code mask sheet 60 includes a plurality of code patterns 61 and a light-blocking area 62. The light- blocking area 62 borders each of the code patterns 61 so as to individually partition the code patterns 61. In the first embodiment, four code patterns 61 are provided on the single code mask sheet 60. As illustrated in FIG. 1, the four code patterns 61 are code patterns 611, 612, 613, and 614. The four code patterns 61 are arranged in a matrix having a row-column configuration. The code pattern 611 is positioned on the yl and xl sides in the code mask sheet 60. The code pattern 612 is positioned on the yl and x2 sides in the code mask sheet 60. The code pattern 613 is positioned on the y2 and x2 sides in the code mask sheet 60. The code pattern 614 is positioned on the y2 and xl sides in the code mask sheet 60. As illustrated in FIG. 2, each of the four (multiple) code patterns 61 in the code mask sheet 60 includes a light-transmitting portion 61a and a light-blocking portion 61b. The total area of the light- transmitting portions 61a in the entire four (multiple) code patterns 61 is 40% to 60% of the total area of the four (multiple) code patterns 61.

The optical shutter 51 is stacked on the zl side (lower side) with respect to the code mask sheet 60. A liquid crystal shutter 82, an electrochromic shutter, or the like that can switch between light-transmitting and light-blocking states is applicable as the optical shutter 51. When a portion of the optical shutter 51 that overlaps one or some of the code patterns 61 as viewed along the z direction is brought into the light-transmitting state, the other portion of the optical shutter 51 is brought into the light-blocking state. For example, when a portion of the optical shutter 51 that overlaps the code pattern 611 illustrated in FIG. 1 as viewed along the z direction is brought into the light-transmitting state, light from the light source 104 passes through the portion of the optical shutter 51, and the light passes through the code pattern 611 and is captured by the optical sensor 10. At this time, the light does not pass through the code patterns 612, 613, and 614.

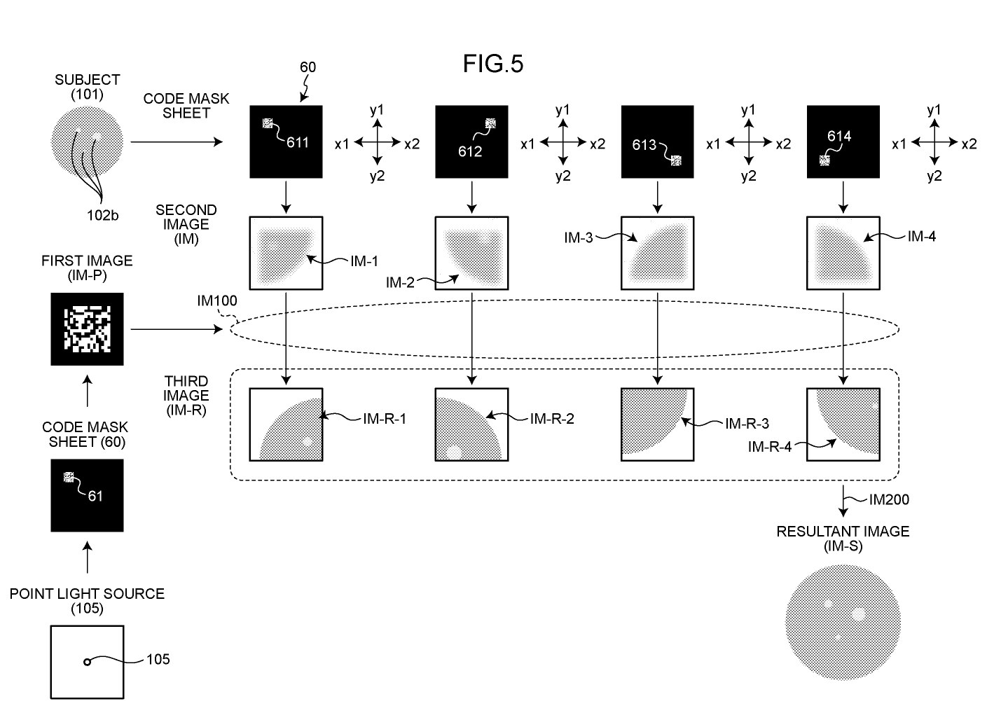

The subject housing 103 is provided on the z1 side with respect to the optical shutter 51 so as to overlap the optical shutter 51. The subject housing 103 accommodates therein a subject 101. The subject housing 103 is a light- transmitting container, such as a Petri dish, for example. The subject 101 is, for example, microorganisms 102b (refer to FIG. 5 to be explained later) placed on a surface 102a of a culture medium 102 (e.g., agar). Specifically, the culture medium 102 is accommodated in the Petri dish, the microorganisms 102b are cultured on the culture medium 102, and the growth of the microorganisms 102b is imaged.

The light source 104 is, for example, a backlight formed in a planar configuration. Specifically, the light source 104 has a plurality of light-emitting diodes (LEDs) or the like arranged in a planar shape to emit light evenly.

FIG. 3 is a block diagram illustrating a configuration example of the imaging device according to the first embodiment. As illustrated in FIG. 3, the imaging device 1 further includes a control circuit 70 that controls the optical sensor 10. The control circuit 70 includes, for example, a microcontrol unit (MCU), a random-access memory (RA4), an electrically erasable programmable read-only memory (EEPROM), a read-only memory (ROM), and other components.

The optical sensor 10 includes an array substrate 2, a plurality of sensor pixels 3 (photodiodes 30) formed on the array substrate 2, gate line drive circuits 15A and 15B, a signal line drive circuit 16A, and an imaging circuit (ROIC) 11. The imaging circuit 11 includes a readout integrated circuit.

The array substrate 2 is formed using a substrate 21 as a base. Each of the sensor pixels 3 is configured with the photodiode 30, a plurality of transistors, and various types of wiring. The array substrate 2 with the photodiodes 30 formed thereon is a drive circuit board for driving the sensor for each predetermined detection area and is also called a backplane or an active matrix substrate.

The substrate 21 has an active area AA and a peripheral area GA. The active area AA is an area provided with the sensor pixels 3 (photodiodes 30). The peripheral area GA is an area between the outer perimeter of the active area AA and the outer edges of the substrate 21 and is an area not provided with the sensor pixels 3. The gate line drive circuits 15A and 15B, the signal line drive circuit 16A, and the imaging circuit 11 are provided in the peripheral area GA.

Each of the sensor pixels 3 is an optical sensor that includes the photodiode 30 as a sensor element. Each of the photodiodes 30 outputs an electrical signal corresponding to light emitted thereto. More specifically, the photodiode 30 is a positive-intrinsic-negative (PIN) photodiode or an organic photodiode (OPD) using an organic semiconductor. The sensor pixels 3 (photodiodes 30) are arranged in a matrix having a row-column configuration in the active area AA. The distance between adjacent two of the sensor pixels 3 (photodiodes 30) is a distance PS1 or PS2.

The imaging circuit 11 is a circuit that supplies control signals Sa, Sb, and Sc to the gate line drive circuits 15A and 15B and the signal line drive circuit 16A, respectively, to control operations of these circuits. Specifically, the gate line drive circuits 15A and 15B output gate drive signals to gate lines based on the control signals Sa and Sb. The signal line drive circuit 16A electrically couples a signal line SLS selected based on the control signal Sc to the imaging circuit 11. The imaging circuit 11 includes a signal processing circuit that processes an imaging signal Vdet from each of the photodiodes 30.

The photodiodes 30 included in the sensor pixels 3 perform detection in response to the gate drive signals supplied from the gate line drive circuits 15A and 15B. Each of the photodiodes 30 outputs the electrical signal corresponding to the light emitted thereto as the imaging signal Vdet to the signal line drive circuit 16A. The imaging circuit 11 is electrically coupled to the photodiodes 30. The imaging circuit 11 processes the imaging signals Vdet from the photodiodes 30 and outputs pixel data Cap based on the imaging signals Vdet to the control circuit 70. The pixel data Cap is sensor values acquired from the respective sensor pixels 3.

The control circuit 70 includes a pixel data storage circuit 71, an image generation circuit 72, a storage circuit 73, and a processing circuit 74, as a control circuit for the optical sensor 10. The pixel data storage circuit 71 stores therein the pixel data Cap output from the imaging circuit 11 of the optical sensor 10. The image generation circuit 72 generates a second image IM obtained by imaging the subject 101 based on the pixel data Cap of the photodiodes 30. The second image IM is an image obtained by capturing, using the optical sensor 10, a light intensity pattern obtained by transmitting the light from the light source 104 through the optical shutter device 50 while the subject 101 is accommodated in the subject housing 103.

The storage circuit 73 stores therein a first image IM-P representing the light intensity pattern captured by the optical sensor 10 in a state where a point light source 105 faces the optical shutter device 50.

The processing circuit 74 brings the portion of the optical shutter 51 that overlaps one or some of the code patterns 61 as viewed along the z direction into the light- transmitting state, and brings the other portion of the optical shutter 51 into the light-blocking state, as described above. The processing circuit 74 also performs image processing to generate a third image IM-R by performing a deconvolution process based on the second image IM and the first image IM-P. The second image IM is obtained by imaging the subject 101 through the code pattern 61 of the optical shutter device 50 using the optical sensor 10. The control circuit 70 transmits the third image IM-R to an external host personal computer (PC) 76. This image processing will be described in detail later with reference to FIG. 5.

The liquid crystal shutter 82 that is an example of the optical shutter 51 includes a plurality of divided areas 820. A control circuit (DDIC-2) 822 supplies a control signal Sg to each of the divided areas 820 to control operations of the divided areas 820. The optical sensor 10 includes the photodetection elements 813 (photodiodes 30). The divided areas 820 of the liquid crystal shutter 82 overlap the photodetection elements 813 of the optical sensor 10 as viewed from the z direction. In detail, for example, each of the divided areas 820 overlaps four of the photodetection elements 813 as viewed from the z direction. Each of the divided areas 820 of the liquid crystal shutter 82 overlaps a corresponding one of the code patterns 61 illustrated in FIG. 1, as viewed from the z direction. The position that transmits light is switched between the positions of the divided areas 820 in a time-divisional manner. In other words, the processing circuit 74 switches the divided area 820 that serves as a light-transmitting portion of the liquid crystal shutter 82 among the divided areas 820 in a time-division manner, thereby sequentially switching a predetermined code pattern 61 that transmits light among the code patterns 61.

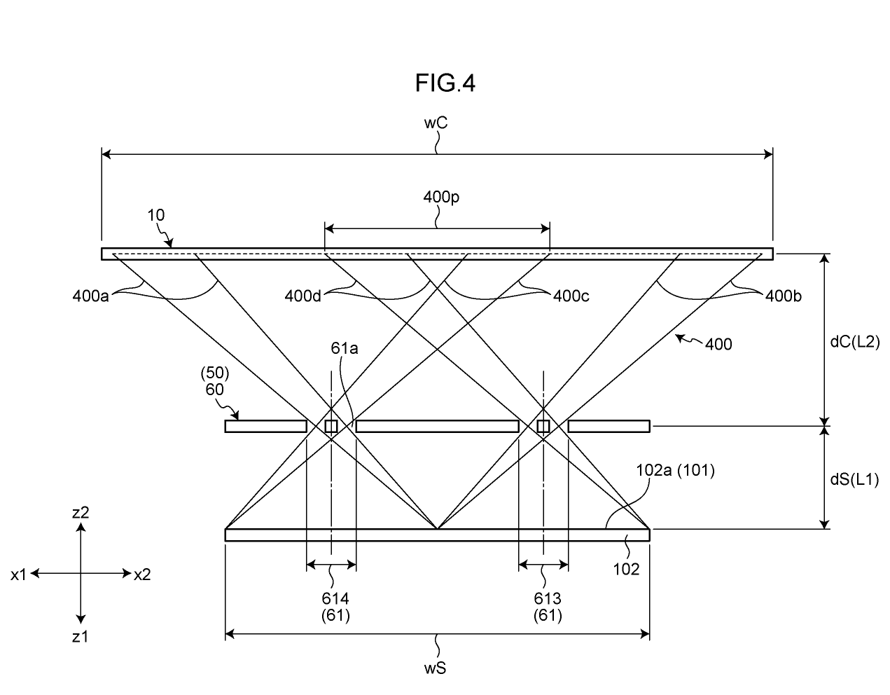

FIG. 4 is a schematic view illustrating a section taken along line IV-IV in FIG. 1. Light passing through the code pattern 61 on the xl side of two of the code patterns 61 illustrated in FIG. 4 spreads from light 400a to light 400c. Light passing through the code pattern 61 on the x2 side spreads from light 400b to light 400d. On the optical sensor 10, the light passing through the code pattern 61 on the xl side overlaps the light passing through the code pattern 61 on the x2 side in the x direction. Therefore, if light simultaneously passes through the code pattern 61 on the xl side and the code pattern 61 on the x2 side, an overlapping portion 400p where the light 400c overlaps the light 400d is formed on the optical sensor 10.

In the present embodiment, however, the predetermined code pattern 61 that transmits light is sequentially switched among the code patterns 61 by switching the portion of the optical shutter 51 to be placed in the light-transmitting state, in a time-division manner. That is, when the light 400a and 400c passing through the code pattern 61 on the xl side is emitted to the optical sensor 10, the light 400b and 400d on the x2 side is not emitted to the optical sensor 10. When the light 400b and 400d passing through the code pattern 61 on the x2 side is emitted to the optical sensor 10, the light 400a and 400c on the xl side is not emitted to the optical sensor 10. Thus, the imaging by the optical sensor 10 is performed at a plurality of imaging times, and at each of the imaging times, no overlapping occurs between image acquisition areas of the optical sensor 10. wS denotes the width in the x direction of the subject 101 (specifically, the width of the surface 102a of the culture medium 102); wC denotes the irradiation width on the optical sensor 10; dS denotes the distance in the z direction from the code mask sheet 60 to the subject 101; and dC denotes the distance in the z direction from the optical sensor 10 to the code mask sheet 60. In more detail, dS is the distance in the z direction from the center in the z direction of the code mask sheet 60 to the microorganisms 102b provided on the surface 102a of the culture medium 102. dC denotes the distance in the z direction from the photodiode 30 of the optical sensor 10 to the center in the z direction of the code mask sheet 60. dS is also referred to as a "first distance Li" and dC as a "second distance L2". The irradiation width wC is larger than the width wS in the x direction. The first distance Li is shorter than the second distance L2.

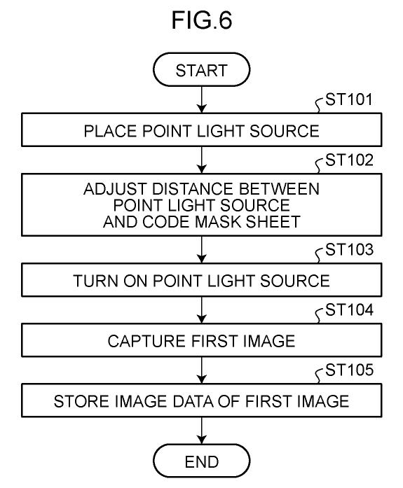

FIG. 5 is a schematic diagram illustrating a procedure of the image processing according to the first embodiment. FIG. 6 is a flowchart illustrating a method for acquiring the first image data according to the first embodiment.

First, the method for acquiring the first image according to the first embodiment will be described with reference to FIGS. 5 and 6. The first image IM-P is the light intensity pattern captured by the optical sensor 10 in the state where the point light source 105 faces the optical shutter device 50. In other words, the first image IM-P is an image obtained by capturing, using the optical sensor 10, the light intensity pattern obtained by transmitting the light from the point light source 105 through the optical shutter device 50 while the subject 101 is not accommodated in the subject housing 103. As illustrated in FIGS. 5 and 6, an operator first places the point light source 105 (Step ST101).

Then, the distance between the point light source 105 and the code mask sheet 60 is adjusted (Step ST102).

Then, the point light source 105 is turned on (Step ST103). As a result, light emitted from the point light source 105 irradiates the photodiodes 30 of the optical sensor 10 through one of the code patterns 61 in the code mask sheet 60, and the first image IM-P is captured by the optical sensor 10 (Step ST104).

Then, the storage circuit 73 (refer to FIG. 3) stores therein the first image IM-P (Step ST105). Specifically, the storage circuit 73 stores therein the first image IM-P that represents the light intensity pattern captured by the optical sensor 10 in the state where the point light source 105 faces the optical shutter device 50. The time to store the data of the first image IM-P is, for example, when the imaging device 1 is designed or shipped, or when the imaging device 1 starts up.

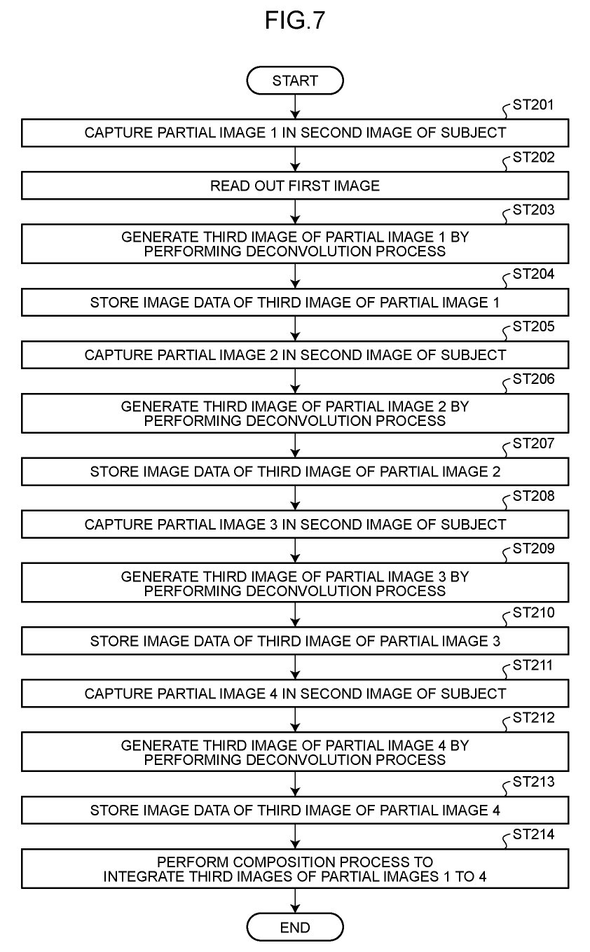

Then, with reference to FIGS. 5 and 7, the following describes a method for generating the third image IM-R and a resultant image IM-S by performing a deconvolution process IM100 using the first image IM-P on the second image IM obtained by imaging the subject 101. FIG. 7 is a flowchart illustrating the method for obtaining the resultant image according to the first embodiment.

The second image IM includes a plurality of partial images (partial images 1 to 4) corresponding to light transmitted through the respective predetermined code patterns 61 that transmit light in a time-division manner. First, as illustrated in FIGS. 5 and 7, the optical sensor 10 captures the partial image 1 (IM-1) in the second image IM of the subject 101 (Step ST201). The partial image 1 (IM-1) is an image corresponding to light transmitted through the code pattern 611 among the four code patterns. The second image IM is rotated 180 degrees with respect to the subject 101.

Then, the first image IM-P is read out (Step ST202). As described above, the data of the first image IM-P is stored in advance in the storage circuit 73.

Then, the processing circuit 74 generates a plurality of the third images IM-R by individually performing the deconvolution process IM100 on a plurality of partial images (IM-1 to IM-4) in the second image IM. Specifically, first, a third image (IM-R-1) of the partial image 1 (IM-1) is generated by performing the deconvolution process IM100 on the partial image 1 (IM-1) in the second image IM (Step ST203).

The control circuit 70 transmits the third image (IM- R-1) to the external host PC 76 (refer to FIG. 3) (Step ST204).

In the procedure described above, the third images are generated in the same way for a partial image 2 (IM-2), a partial image 3 (IM-3), and a partial image 4 (IM-4). The following briefly describes the generation of the third images (IM-R) of the partial image 2 (IM-2) to the partial image 4 (IM-4).

The optical sensor 10 captures the partial image 2 (IM-2) in the second image IM of the subject 101 (Step ST205). The partial image 2 (IM-2) is an image corresponding to light transmitted through the code pattern 612 among the four code patterns. Then, a third image (IM- R-2) of the partial image 2 (IM-2) is generated by performing the deconvolution process IM100 (Step ST206). The control circuit 70 transmits the third image (IM-R-2) to the external host PC 76 (refer to FIG. 3) (Step ST207).

The optical sensor 10 captures the partial image 3 (IM-3) in the second image IM of the subject 101 (Step ST208). The partial image 3 (IM-3) is an image corresponding to light transmitted through the code pattern 613 among the four code patterns. Then, a third image (IM- R-3) of the partial image 3 (IM-3) is generated by performing the deconvolution process IM100 (Step ST209). The control circuit 70 transmits the third image (IM-R-3) to the external host PC 76 (refer to FIG. 3) (Step ST210).

The optical sensor 10 captures the partial image 4 (IM-4) in the second image IM of the subject 101 (Step ST211). The partial image 4 (IM-4) is an image corresponding to light transmitted through the code pattern 614 among the four code patterns. Then, a third image (IM- R-4) of the partial image 4 (IM-4) is generated by performing the deconvolution process IM100 (Step ST212). The control circuit 70 transmits the third image (IM-R-4) to the external host PC 76 (refer to FIG. 3) (Step ST213).

Then, a composition process IM200 is performed to integrate the third images of the partial images 1 to 4 with one another (Step ST214). The composition process IM200 is a process to determine the distances among the generated third images based on the first distance Li and the second distance L2 and integrate the third images (IM- R) with one another. Thus, at Step ST214, the composition process IM200 is performed to integrate the third images (IM-R-1), (IM-R-2), (IM-R-3), and (IM-R-4). This composition process IM200 generates the resultant image IM- S. The processing circuit 74 performs the composition process IM200.

As described above, the imaging device 1 includes the optical sensor 10, the optical shutter device 50, the subject housing 103, and the processing circuit 74. The optical shutter device 50 includes the code mask sheet 60 that includes the code patterns 61 and the light-blocking area 62, and the optical shutter 51. The processing circuit 74 brings the portion of the optical shutter 51 that overlaps one or some of the code patterns 61 as viewed along the z direction into the light-transmitting state, and brings the other portion of the optical shutter 51 into the light-blocking state.

As described above with reference to FIG. 4, the light from the light source 104 passes through the subject 101 in the subject housing 103, passes through the code pattern 61 of the code mask sheet 60, and then irradiates the optical sensor 10. If light rays simultaneously pass through adjacent two of the code patterns 61, the overlapping portion 400p where the light rays overlap each other may be formed on the optical sensor 10. That is, if light rays simultaneously pass through all the code patterns 61, the distance in the z direction between the optical shutter device 50 and the optical sensor 10 needs to be made longer so that the light rays do not overlap each other on the optical sensor 10.

In contrast, in the present embodiment, a portion of the optical shutter 51 that overlaps one or some of the code patterns 61 as viewed along the z direction is brought into the light-transmitting state, and a portion of the other portion of the optical shutter 51 is brought into the light-blocking state. This processing allows the light to sequentially pass through one or some of the code patterns 61 at a time. Therefore, even if the distance in the z direction between the optical shutter device 50 and the optical sensor 10 is set shorter, the light rays transmitted through the adjacent code patterns 61 do not overlap each other on the optical sensor 10.

From the above, the present embodiment can provide the imaging device 1 having a smaller overall size and being capable of capturing clearer images with reduced blur.

By performing the imaging for each area in a time- division manner using the optical shutter 51, the second distance L2 can be made smaller than in a case where the optical shutter 51 is not provided.

The processing circuit 74 performs the image processing to generate the third images IM-R by performing the deconvolution process IM100 based on the second image IM and the first image IM-P. The second image IM is obtained by imaging the subject 101 through the code pattern 61 of the optical shutter device 50 using the optical sensor 10.

As described above, in JP-A-2024-001293, the focal length needs to be set larger, which may increase the overall size of the device. In JP-5839428, the amount of light passing through the pinhole is limited, which may make it difficult to capture clear images.

In contrast, in the present embodiment, the third image IM-R is generated by performing the deconvolution process IM100 based on the second image IM and the first image IM-P. Therefore, compared with the imaging device including the lens according to JP-A-2024-001293, the imaging device 1 according to the present embodiment can make the overall size of the device smaller. Since the pinhole camera according to JP-5839428 lacks the amount of light, the imaging device 1 according to the present embodiment can generate clearer images than in JP-5839428 without lacking the amount of light. From the above, according to the present embodiment, the imaging device 1 can be provided that has a smaller overall size and can capture clearer images with reduced blur.

The processing circuit 74 switches the portion of the optical shutter 51 to be brought into the light- transmitting state in a time-division manner, thereby sequentially switching the predetermined code pattern 61 that transmits light among the code patterns 61. The second image IM includes the partial images (partial images 1 to 4) corresponding to the light transmitted through the respective predetermined code patterns 61 that transmit light in a time-division manner. The processing circuit 74 generates the third images IM-R by individually performing the deconvolution process IM100 on the partial images, determines the distances between the generated third images IM-R based on the first distance Li and the second distance L2, and performs the composition process IM200 to integrate the third images IM-R with one another.

Since this processing allows the light to pass through one or some of the code patterns 61 at a time and sequentially pass through each code pattern 61 in a time- division manner, the light rays transmitted through the adjacent code patterns 61 do not overlap on the optical sensor 10 even if the second distance L2 in the z direction between the optical shutter device 50 and the optical sensor 10 is set shorter. Therefore, the present embodiment can provide the imaging device 1 having a smaller overall size and being capable of capturing clearer images with reduced blur.

The total area of the light-transmitting portions 61a in the entire code patterns 61 is 40% to 60% of the total area of the code patterns 61. If the percentage is less than 40%, the image becomes darker, and if the percentage is more than 60%, the quality of the deconvolution process IM100 becomes lower, both of which are disadvantages. Thus, the percentage is preferably 40% to 60%, so that an image with proper brightness is obtained.

The optical shutter 51 is the liquid crystal shutter 82 or the electrochromic shutter. Accordingly, the portion of the optical shutter 51 to be placed in the light- transmitting state can be easily switched in a time- division manner. In particular, the liquid crystal shutter 82 can switch the portion placed in the light-transmitting state more quickly.

### Second Embodiment

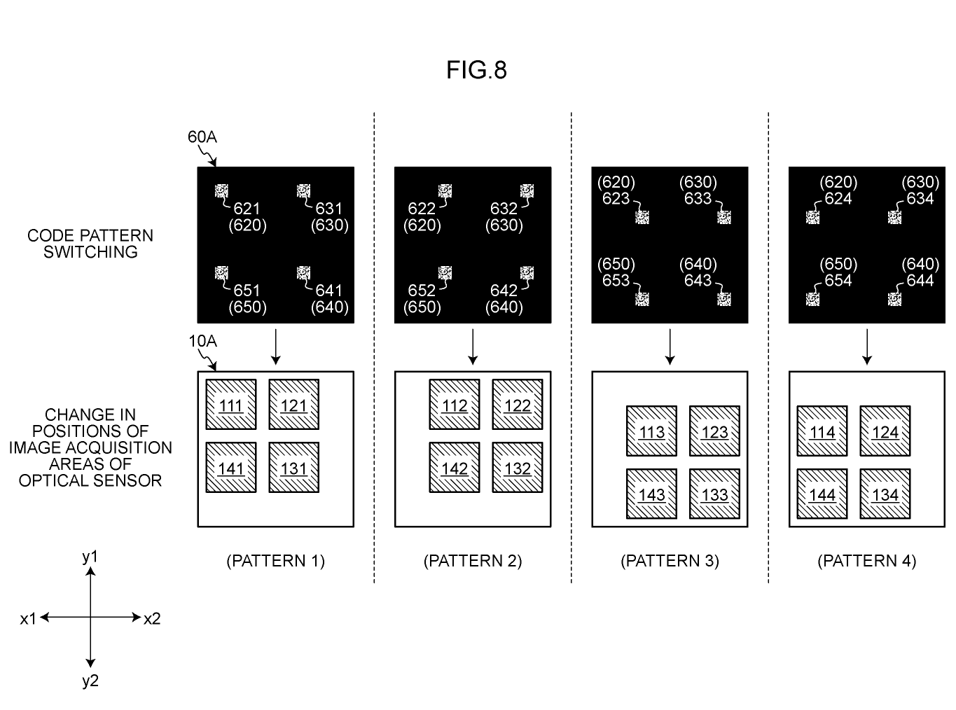

The following describes a second embodiment of the present disclosure. FIG. 8 is a schematic diagram illustrating a procedure of image processing according to the second embodiment.

In the first embodiment, the code mask sheet 60 including the four code patterns 61 (code patterns 611, 612, 613, and 614) has been applied, as illustrated in FIG.

1. In the second embodiment, four (two or more) code pattern groups 620, 630, 640, and 650 are provided, and a code mask sheet 60A including four (multiple) code patterns is applied to each of the code pattern groups 620, 630, 640, and 650.

Specifically, as illustrated in the upper portion of FIG. 8, the code mask sheet 60A is rectangular in plan view. The code pattern group 620 is positioned on the xl and yl sides in the code mask sheet 60A. The code pattern group 630 is positioned on the x2 and yl sides in the code mask sheet 60A. The code pattern group 640 is positioned on the x2 and y2 sides in the code mask sheet 60A. The code pattern group 650 is positioned on the xl and y2 sides in the code mask sheet 60A.

Each of the code pattern groups is provided with four code patterns 61. Specifically, the code pattern group 620 is provided with code patterns 621, 622, 623, and 624. The code pattern 621 is positioned on the xl and yl sides in the code pattern group 620. The code pattern 622 is positioned on the x2 and yl sides in the code pattern group 620. The code pattern 623 is positioned on the x2 and y2 sides in the code pattern group 620. The code pattern 624 is positioned on the xl and y2 sides in the code pattern group 620.

The code pattern group 630 is provided with code patterns 631, 632, 633, and 634. The code pattern 631 is positioned on the xl and y1 sides in the code pattern group 630. The code pattern 632 is positioned on the x2 and yl sides in the code pattern group 630. The code pattern 633 is positioned on the x2 and y2 sides in the code pattern group 630. The code pattern 634 is positioned on the xl and y2 sides in the code pattern group 630.

The code pattern group 640 is provided with code patterns 641, 642, 643, and 644. The code pattern 641 is positioned on the xl and yl sides in the code pattern group 640. The code pattern 642 is positioned on the x2 and yl sides in the code pattern group 640. The code pattern 643 is positioned on the x2 and y2 sides in the code pattern group 640. The code pattern 644 is positioned on the xl and y2 sides in the code pattern group 640.

The code pattern group 650 is provided with code patterns 651, 652, 653, and 654. The code pattern 651 is positioned on the xl and y1 sides in the code pattern group 650. The code pattern 652 is positioned on the x2 and y1 sides in the code pattern group 650. The code pattern 653 is positioned on the x2 and y2 sides in the code pattern group 650. A code pattern 654 is positioned on the xl and y2 sides in the code pattern group 650.

With the configuration described above, in the case of the leftmost pattern 1, the code pattern 621 of the code pattern group 620, the code pattern 631 of the code pattern group 630, the code pattern 641 of the code pattern group 640, and the code pattern 651 of the code pattern group 650 are brought into the light-transmitting state in the code mask sheet 60A.

In the case of the second leftmost pattern 2, the code pattern 622 of the code pattern group 620, the code pattern 632 of the code pattern group 630, the code pattern 642 of the code pattern group 640, and the code pattern 652 of the code pattern group 650 are brought into the light- transmitting state in the code mask sheet 60A.

In the case of the third leftmost pattern 3, the code pattern 623 of the code pattern group 620, the code pattern 633 of the code pattern group 630, the code pattern 643 of the code pattern group 640, and the code pattern 653 of the code pattern group 650 are brought into the light- transmitting state in the code mask sheet 60A.

In the case of the fourth leftmost pattern 4, the code pattern 624 of the code pattern group 620, the code pattern 634 of the code pattern group 630, the code pattern 644 of the code pattern group 640, and the code pattern 654 of the code pattern group 650 are brought into the light- transmitting state in the code mask sheet 60A.

Thus, in the second embodiment, one predetermined code pattern provided in each of the four code pattern groups 620, 630, 640, and 650 is sequentially switched one by one.

As illustrated in the lower portion of FIG. 8, an optical sensor 10A individually generates partial images in a plurality of portions divided so that the image acquisition areas do not overlap one another in patterns 1 to 4.

Specifically, first, in the case of the leftmost pattern 1 in FIG. 8, image acquisition areas 111, 121, 131, and 141 are arranged so as not to overlap one another in the optical sensor 10A. The image acquisition area 111 corresponds to the code pattern 621; the image acquisition area 121 corresponds to the code pattern 631; the image acquisition area 131 corresponds to the code pattern 641; and the image acquisition area 141 corresponds to the code pattern 651.

In the case of pattern 2, image acquisition areas 112, 122, 132, and 142 are arranged so as not to overlap one another in the optical sensor 10A. The image acquisition area 112 corresponds to the code pattern 622; the image acquisition area 122 corresponds to the code pattern 632; the image acquisition area 132 corresponds to the code pattern 642; and the image acquisition area 142 corresponds to the code pattern 652.

In the case of pattern 3, image acquisition areas 113, 123, 133, and 143 are arranged so as not to overlap one another in the optical sensor 10A. The image acquisition area 113 corresponds to the code pattern 623; the image acquisition area 123 corresponds to the code pattern 633; the image acquisition area 133 corresponds to the code pattern 643; and the image acquisition area 143 corresponds to the code pattern 653.

In the case of pattern 4, image acquisition areas 114, 124, 134, and 144 are arranged so as not to overlap one another in the optical sensor 10A. The image acquisition area 114 corresponds to the code pattern 624; the image acquisition area 124 corresponds to the code pattern 634; the image acquisition area 134 corresponds to the code pattern 644; and the image acquisition area 144 corresponds to the code pattern 654.

As described above, in the second embodiment, the code mask sheet 60A is provided with the four (two or more) code pattern groups 620, 630, 640, and 650, and each of the four code pattern groups 620, 630, 640, and 650 includes a plurality of code patterns (code pattern 621 to code pattern 654). The second image IM is captured at four (multiple) imaging times. At each of the four imaging times, the partial images are individually generated in the multiple portions divided so that the image acquisition areas (image acquisition area 111 to image acquisition area 144) of the optical sensor 10A do not overlap one another, and each of the partial images reflects the light intensity pattern produced by light transmitted through one code pattern (one of code patterns 621 to 654).

In the first embodiment, four code patterns 61 are provided on one code mask sheet 60. In contrast, in the second embodiment, a total of 16 code patterns 61 are provided on one code mask sheet 60, and the image acquisition areas of the optical sensor 10A do not overlap one another at each of the imaging times. Therefore, according to the second embodiment, the number of divisions is increased from 4 to 16, whereby Li and L2 can be shortened to downsize the device.

### Third Embodiment

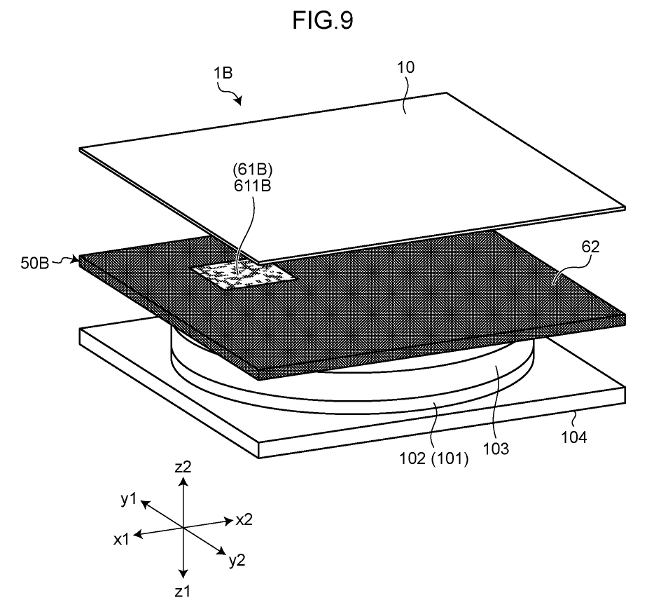

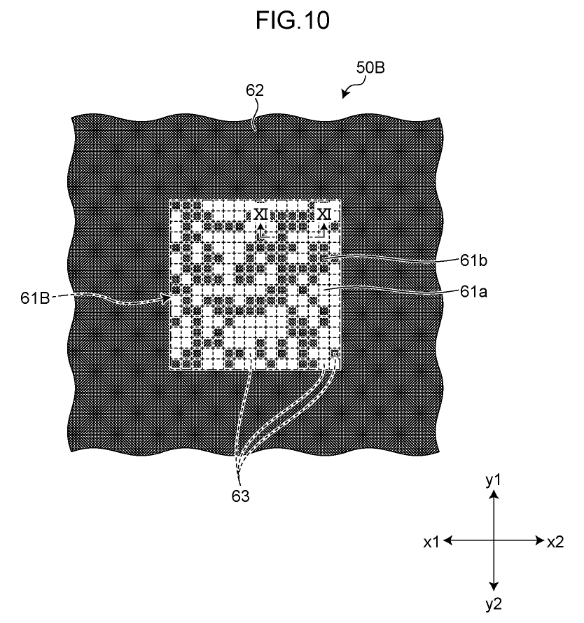

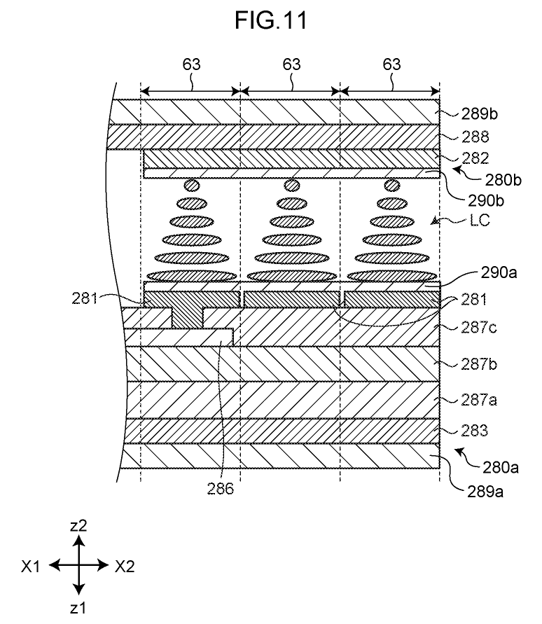

The following describes a third embodiment of the present disclosure. An optical shutter device 50B according to the third embodiment can switch the display of the code patterns. In other words, in the optical shutter device 50B, as an example, the optical shutter has a pixel structure to configure the code mask. FIG. 9 is a perspective view schematically illustrating an imaging device according to the third embodiment. FIG. 10 is an enlarged schematic view of a portion of an optical shutter device in FIG. 9. FIG. 11 is a schematic sectional view taken along line XI-XI in FIG. 10. A specific explanation will be made below.

An imaging device 1B illustrated in FIG. 9 includes the optical shutter device 50B. In the optical shutter device 50B, only a code pattern 611B is in the light- transmitting state among four code patterns 61B. The entire surface of the optical shutter device 50B is divided into a plurality of square pixels 63, as illustrated in FIG. 10. In detail, in the code pattern 611B, the pixels 63 in the light-transmitting state form the light- transmitting portion 61a, and the pixels 63 in the light- blocking state form the light-blocking portion 61b. The light-blocking area 62 is formed by the pixels 63 in the light-blocking state.

As illustrated in FIG. 11, light can be transmitted or blocked by a polarizer on a light emission side of a liquid crystal layer LC by controlling the twisting state of liquid crystal molecules by turning on or off the voltage applied to electrodes for each pixel 63. That is, portions that transmit light form the light-transmitting portions 61a, and portions that block light form the light-blocking portions 61b and the light-blocking area 62.

As illustrated in FIG. 11, the pixel structure divided for each of the pixels 63 includes a first substrate 280a, a second substrate 280b, and the liquid crystal layer LC. Specifically, the second substrate 280b is spaced on the z2 side from the first substrate 280a, and the liquid crystal layer LC is provided between the second substrate 280b and the first substrate 280a.

The first substrate 280a includes a first polarizer 289a, a first transparent substrate 283, an insulating layer 287a, an insulating layer 287b, an insulating layer 287c, a first electrode 281, and a first orientation film 290a. Specifically, the first polarizer 289a, the first transparent substrate 283, the insulating layer 287a, the insulating layer 287b, the insulating layer 287c, the first electrode 281, and the first orientation film 290a are stacked in this order from the zl side toward the z2 side.

The second substrate 280b includes a second polarizer 289b, a second transparent substrate 288, a second electrode 282, and a second orientation film 290b. Specifically, the second polarizer 289b, the second transparent substrate 288, the second electrode 282, and the second orientation film 290b are stacked in this order from the z2 side toward the zl side.

The first polarizer 289a and the second polarizer 289b are polarizers that each transmit components of incident light that vibrate in a predetermined direction and block components of the light that vibrate in directions other than that direction.

The first transparent substrate 283 and the second transparent substrate 288 are glass substrates, for example. The first electrode 281 and the second electrode 282 are light-transmitting electrodes using indium tin oxide (ITO), for example. The first orientation film 290a and the second orientation film 290b are made of polyimide (PI), for example. The orientation films are each provided to control the orientation of the liquid crystal molecules when the liquid crystal molecules are required to be aligned in one direction over a relatively wide area. The first electrode 281 is electrically coupled to wiring 286. A switch or the like (not illustrated) causes current to flow to the first electrode 281 through the wiring 286.

With the configuration described above, the pixels 63 where current is caused to flow to the first electrode 281 become the light-transmitting portions 61a in the light- transmitting state, and the pixels 63 in the light-blocking state where current is not allowed to flow to the first electrode 281 become the light-blocking portions 61b and the light-blocking area 62. Thus, for example, in FIG. 9, the code pattern 611B is brought into the light- transmitting state.

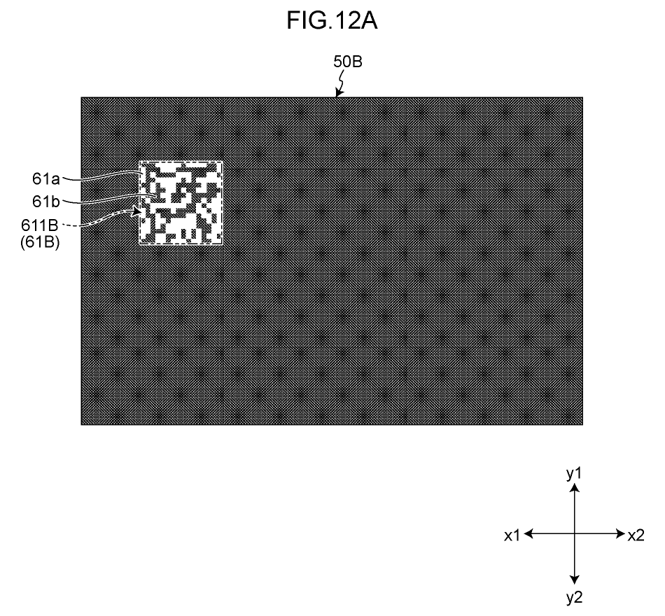

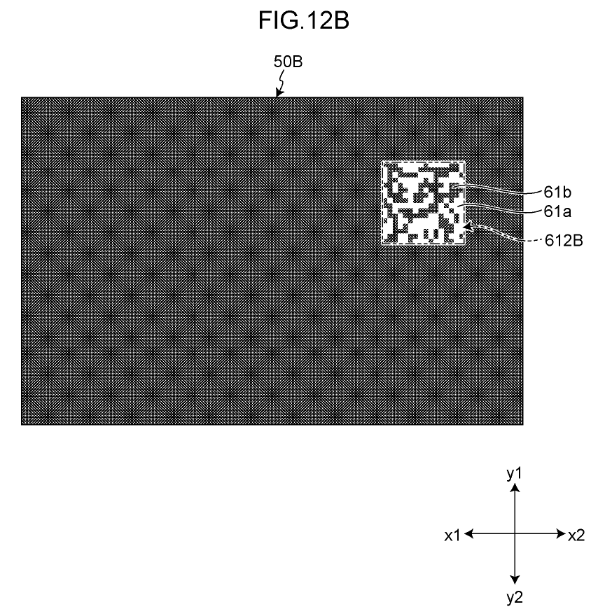

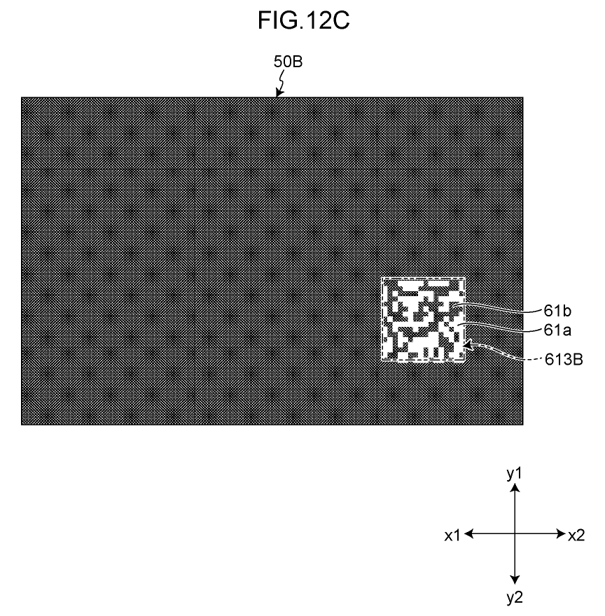

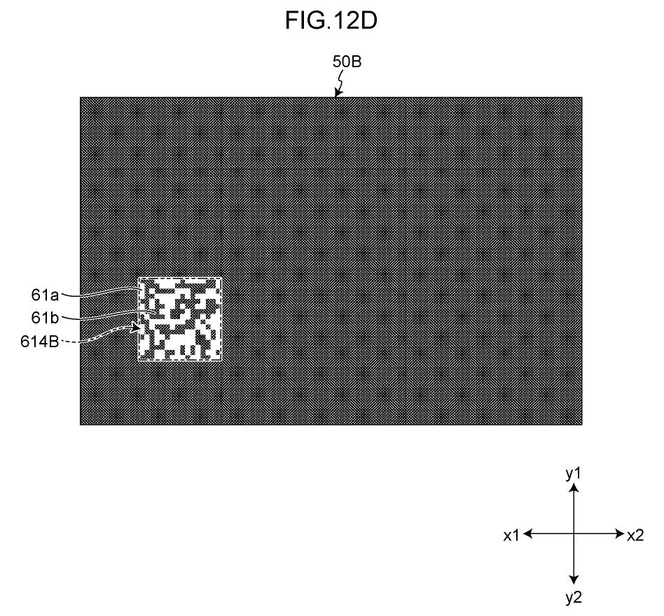

Also, in the third embodiment, the predetermined code pattern 61B that transmits light can be sequentially switched in a time-division manner. FIG. 12A is a plan view of the optical shutter device illustrating a state in which a first code pattern of the four code patterns transmits light. FIG. 12B is a plan view of the optical shutter device illustrating a state in which a second code pattern of the four code patterns transmits light. FIG. 12C is a plan view of the optical shutter device illustrating a state in which a third code pattern of the four code patterns transmits light. FIG. 12D is a plan view of the optical shutter device illustrating a state in which a fourth code pattern of the four code patterns transmits light.

The four code patterns 61B in the third embodiment are code patterns 611B, 612B, 613B, and 614B. The code pattern 611B in FIG. 12A corresponds to the code pattern 611 in FIG. 5. In FIG. 12A, the pixels 63 of the light- transmitting portions 61a in the code pattern 611B are brought into the light-transmitting state, and the remaining pixels 63 are brought into the light-blocking state. The code pattern 612B in FIG. 12B corresponds to the code pattern 612 in FIG. 5. In FIG. 12B, the pixels 63 of the light-transmitting portions 61a in the code pattern 612B are brought into the light-transmitting state, and the remaining pixels 63 are brought into the light-blocking state. The code pattern 613B in FIG. 12C corresponds to the code pattern 613 in FIG. 5. In FIG. 12C, the pixels 63 of the light-transmitting portions 61a in the code pattern 613B are brought into the light-transmitting state, and the remaining pixels 63 are brought into the light-blocking state. The code pattern 614B in FIG. 12D corresponds to the code pattern 614 in FIG. 5. In FIG. 12D, the pixels 63 of the light-transmitting portions 61a in the code pattern 614B are brought into the light-transmitting state, and the remaining pixels 63 are brought into the light-blocking state.

Thus, the predetermined code pattern 61B that transmits light is switched in a time-division manner sequentially from the code pattern 611B to the code pattern 614B.

As described above, also, in the third embodiment, light can be sequentially transmitted through one or some of the code patterns 61B at a time by bringing the one or some of the code patterns 61B into the light-transmitting state.

What is claimed is:

1. An imaging device comprising:
a planar optical sensor comprising a plurality of photodiodes;
an optical shutter device that is provided on one side in a first direction with respect to the optical sensor so as to overlap the optical sensor and is capable of switching display of a plurality of code patterns;
a subject housing that is provided on one side in the first direction with respect to the optical shutter device so as to overlap the optical shutter device and is configured to accommodate a subject; and
a processing circuit configured to bring a portion of the optical shutter device that overlaps one or some of the code patterns as viewed along the first direction into a light-transmitting state, and bring another portion of the optical shutter device into a light-blocking state.

2. The imaging device according to claim 1, wherein the optical shutter device comprises:
a code mask sheet that is provided on one side in the first direction with respect to the optical sensor so as to overlap the optical sensor, and comprises the code patterns and a light-blocking area that borders each of the code patterns so as to individually partition the code patterns;
and an optical shutter that is stacked on one side in the first direction with respect to the code mask sheet and is switchable between light-transmitting and light-blocking states.

3. The imaging device according to claim 1, wherein the processing circuit is configured to control operations of the optical sensor, and
when a first distance denotes a distance in the first direction between the subject housing and the optical shutter device and a second distance denotes a distance in the first direction between the optical shutter device and the optical sensor,
the processing circuit is capable of changing at least one of a size or a shape of an image captured by the optical sensor correspondingly to the first distance and the second distance.

4. The imaging device according to claim 3, wherein the first distance is shorter than the second distance.

5. The imaging device according to claim 1, further comprising a storage circuit configured to store a first image that represents a light intensity pattern captured by the optical sensor in a state where a point light source faces the optical shutter device, wherein
the processing circuit is configured to perform image processing to generate a third image by performing a deconvolution process based on a second image and the first image, and the second image is an image obtained by imaging the subject through the code pattern of the optical shutter device using the optical sensor.

6. The imaging device according to claim 5, wherein the processing circuit is configured to sequentially switch a predetermined code pattern that transmits light among the code patterns by switching a portion of the optical shutter device to be brought into the light-transmitting state in a time-division manner.

7. The imaging device according to claim 6, wherein the processing circuit is configured to control operations of the optical sensor,
when a first distance denotes a distance in the first direction between the subject housing and the optical shutter device and a second distance denotes a distance in the first direction between the optical shutter device and the optical sensor,
the second image comprises a plurality of partial images corresponding to light transmitted through the respective predetermined code patterns that transmit the light in a time-division manner, and
the processing circuit is configured to generate the third images by individually performing the deconvolution process on the partial images, determine distances between the generated third images based on the first distance and the second distance, and perform a composition process to integrate the third images with one another.

8. The imaging device according to claim 7, wherein the optical shutter device is provided with two or more code pattern groups, and each of the two or more code pattern groups comprises the code patterns, and
the second image is captured at a plurality of imaging times; at each of the imaging times, the partial images are individually generated in a plurality of portions divided so that image acquisition areas of the optical sensor do not overlap one another; and each of the partial images reflects the light intensity pattern produced by light transmitted through one of the code patterns.

9. The imaging device according to claim 1, wherein each of the code patterns in the optical shutter device comprises a light-transmitting portion and a light-blocking portion, and a total area of the light-transmitting portions in the entire code patterns is 40% to 60% of a total area of the code patterns.

10. The imaging device according to claim 2, wherein the optical shutter is an electrochromic shutter.

11. The imaging device according to claim 2, wherein the optical shutter is a liquid crystal shutter.
